(19) United States
(12) Patent Application Publication
(10) Pub. No.: US 2014/0023815 A1
(43) Pub. Date: Jan. 23, 2014

(54) COMPLIANCE AID FOR ADMINISTERING MEDICATIONS AND THE LIKE

(71) Applicant: Kerren Steckler, Charlestown, MA (US)

(72) Inventor: Kerren Steckler, Charlestown, MA (US)

(21) Appl. No.: 13/930,985

(22) Filed: Jun. 28, 2013

Related U.S. Application Data
(60) Provisional application No. 61/666,154, filed on Jun. 29, 2012.
(60) Provisional application No. 61/813,301, filed on Apr. 18, 2013.

(51) Int. Cl. G09F 3/10

(52) U.S. Cl. CPC G09F 3/10
USPC 428/42.1

(57) ABSTRACT

A compliance aid to facilitate administration of medications and the like is described. The device provides a record of the dosage history and includes a panel attachable to the container for the medication. The panel has an array of detachable stickers arranged to provide an indication that a dose has been administered and to provide an incentive for children to take the dosage.

### CLAIM TO BENEFIT OF EARLIER FILED PROVISIONAL APPLICATIONS

This application claims priority to earlier filed co-pending U.S. Provisional Patent Applications Ser. No. 61/666,154, filed Jun. 29, 2012 and U.S. Provisional Application Ser. No. 61/813,301 filed Apr. 18, 2013.

The entire teachings, disclosures, and contents of the above referenced Provisional Patent Applications are hereby incorporated by reference in their entirety.

### FIELD OF THE INVENTION

The invention relates to a compliance aid to facilitate administration of medications and to provide a record of the dosage history.

### BACKGROUND OF THE INVENTION

Doctors prescribe a variety of medications to patients that must be taken at periodic intervals and/or specific dosage amounts over time. As an example, for a patient being treated with antibiotics, the patient may need to take a given antibiotic drug twice a day at certain times of the day (e.g. once in the morning and once in the evening) to enable that patients have a consistent amount of the antibiotic within their body over the course of treatment (e.g. over a 10 day period of time). Additionally, non-medicinal treatments, such as skincare products or vitamins that require periodic application or administration sometimes may be forgotten, particularly with individuals with busy schedules. Depending upon a type of medication, ailment of a person, substance or purposes of treatment or application, various application regimens exists for various medications and substances.

While taking prescribed medications or other substances and keeping a record of the dosages taken or frequencies of application is an important part of one's health management, compliance with prescribed medication regimens and keeping useful records often is less than ideal. It is not uncommon for patients who have been prescribed a course of treatment that includes periodic dosages of medicine or other substances, a supplement or the like simply forget to take the medicine or substance and/or neglect to make a record that the medicine has been taken or that a physiological condition relating to the treatment has been noted (e.g., fever, etc.). These difficulties may be more prevalent in connection with elderly people who may have difficulty managing a regimen of medications and records as well as with younger adults, for example, in the case of busy parents who may not remember whether or when they administered a particular medication to the child. Confusion also may arise in circumstances where a patient has multiple caregivers and there is some uncertainty whether a previous caregiver administered a particular dose of medication to the patient.

Administration of medication or a systematic application of a substance or procedure to children often presents an additional difficulty where the child is reluctant or resistant to taking the medication, substance or treatment. This may be overcome by refocusing the child's attention, for example, on something more appealing to the child such as a reward for taking the medicine, applying the substance or administering a treatment. Difficulties in compliance with medication regimens as well as related record keeping have been recognized and many conventional approaches have been taken in an attempt to overcome these difficulties. Conventional record-keeping aids in the form of bedside charts in which healthcare professionals must make manual entries concerning administration of medications have long been used in hospitals and other healthcare facilities. While such conventional manual entry practice may be useful in an institutional setting it is less effective in a home or personal setting particularly where the individuals involved are busy and have other unrelated demands on their time. Keeping a conventional log requires a pen or pencil that may be misplaced. Other devices such as pillboxes cannot track liquid medications. Electromechanical devices such as dispensers and electronic aids, smartphones or computer applications have been used to remind and to track administration of medication, but such conventional aids may not readily lend themselves to use by the patients themselves or by a busy parent or nonprofessional caregiver or in a setting in which multiple caregivers are involved.

Embodiments disclosed herein are based in part on an observation that it would be desirable to provide a simple, easy to use, tracking device attachable directly to a container for the medication and from which one can determine, at a glance, whether the most recent dosage was administered, when the next dosage is due and, in some circumstances, to make a manual record of a particular condition.

In accordance with one example embodiment, a compliance aid is disclosed that is operable to be attached directly to a container for a medication or supplement (e.g. to a prescription medicine bottle) so that it is readily available and secures to the medication container at all times. In one example, the device is in the form of a sheet-like panel having a supporting release layer and a top layer releasably adhered to the support layer. As an example, the layers can form a set of removable stickers and backing from which the stickers can be removed. In this example embodiment, the top layer (e.g. removable stickers) is/are imprinted with a plurality of images arranged, for example, in a grid-like array of columns and rows that together define a plurality of cells, with each of the images being contained in an area of a cell. An upper segment of the panel may include a header with a defined space to note the person or patient's name and also to provide a means by which the panel may be attached to the container. In this example, the panel is partially die cut through the top layer around each of the imprinted images so that the portions of the top layer that include the images may function as a detachable sticker. The grid may have one row for each time interval (e.g., a day) during which dosages are to be administered and a column for each dose to be administered during that day. One column may be reserved to identify the day or date for a particular row. When a dose is administered, the sticker associated with that dose is detached from the panel (e.g. by the patient, or person administering the dosage such as a Doctor, nurse or a parent of a child). In this configuration, the device and apparatus disclosed herein enable rapid indication, from a glance at the panel, by the absence of the image from the cell for that dose, which doses have been taken and which doses remain to be taken at later times. The images on the detachable stickers should be visually distinguishable from the supporting release layer so the absence of a sticker will be immediately apparent.

In another aspect of the invention, the images on the stickers may be selected from images intended to appeal to children, for example, images of likeable characters familiar to them, reward icons and the like so that the device serves a dual function, to track the medication routine and provide a built-in reward to motivate the child receiving the medication. In a further aspect of the invention the panel may include perforations extending through the full thickness of the panel along lines that separate at least some of the columns so that if the number of required daily dosages of medication are fewer than the number of columns in the panel as originally provided (e.g. as when the device is purchased from a store), the unneeded columns may be separated from the panel to provide an array corresponding to the number of doses to be administered.

The invention also may be employed in circumstances where a record of dosages is maintained while also enabling written notes to be made on the panel, such as when administering medication to a patient having fever where it is desirable to track the patient's temperature.

### DESCRIPTION OF THE DRAWINGS

The various objects and advantages of the invention will be appreciated more fully from the following description of the invention together with the drawings in which:

FIG. 1 is an illustration of the front face of an exemplary panel incorporating the invention before attached to a container;

FIG. 2 is a sectional illustration of the panel of FIG. 1 as seen along the line 2-2 of FIG. 1;

FIG. 3 is an illustration of another exemplary embodiment of the invention having record-keeping cells in addition to detachable stickers;

FIG. 4 is an illustration of another embodiment of the invention;

FIG. 4A is an illustration of the embodiment of FIG. 4 with several stickers remove to show that those dosages have been administered;

FIG. 5 is a view of the back side of the panel of FIG. 4;

FIG. 6 is an illustration of another embodiment of a panel;

FIG. 6A is an illustration of the embodiment of FIG. 6 with several stickers remove to show that those dosages have been administered;

FIG. 7 is a view of the back side of the panel of FIG. 6;

FIG. 8 is an illustration of an attachment device to attach a panel to the container; and

FIG. 9 is a side view of a panel attached to the attachment device of FIG. 8;

FIG. 9A is an illustration of the embodiment of a double panel of the type shown in FIG. 9 before the panel is folded and before the attachment device is coupled to the panel;

FIGS. 10A-10E are illustrations of different panels and the device shown in FIG. 9 attached to various types of containers.

FIG. 10F is an illustration of the embodiment of FIG. 10C with several stickers remove to show that those dosages have been administered;

FIG. 10G is an illustration of the embodiment of FIG. 10D with several stickers remove to show that those dosages have been administered;

### DETAILED DESCRIPTION

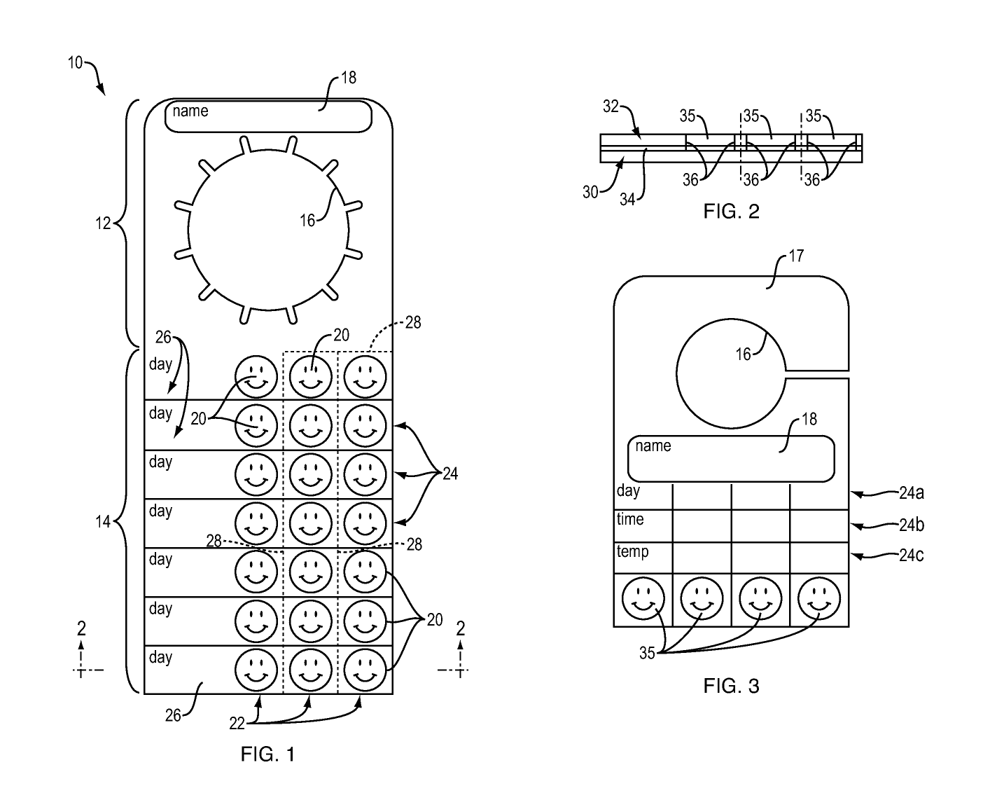

FIG. 1 illustrates one embodiment of a device embodying the invention, which is adapted to be attached to a bottle-like container of pills, liquid medications, supplements or the like. The device is in the form of a flexible panel 10 having an upper segment 12 and a lower segment 14. The upper segment 12 may be provided with an aperture 16 so that it can be placed over the neck of the container so that the device will be attached and will be readily available whenever medication is dispensed. In this example then, the aperture 16 operates as an attachment mechanism to secure the apparatus as disclosed herein to a dispensing container that can be a medicine bottle in this example. A portion 18 of the upper segment may provide space in which the patient's name and instructions may be applied.

The lower portion of the panel is arranged to include, in this example, a plurality of images 20 arranged in a grid of columns 22 and rows 24, each of the images being considered as within a cell defined by the grid. One column, such as the first column, may define spaces 26 where a day or date may be inserted or imprinted in association with each row. The number of columns containing the images should correspond to the number of dosages that are to be administered each day. Thus, in the example embodiment shown in FIG. 1 three columns 22 of images are provided indicating that three doses of the medication are to be given each day. Should there be more columns of images on a panel than the number of doses to be given each day the panels may be preformed with perforation lines 28 to remove one or more columns leaving the number of columns corresponding to the number of doses to be given daily.

In this example the panel preferably is formed to have two layers including a supportive release layer 30 and a top layer 32 that is detachably adhered to the supportive release layer as by an adhesive film 34. The top layer may be imprinted with the images 20 and may be imprinted with days of the week in the first column, although the first column could be left blank should it be desired to manually insert information. The imprinted panel then is partially die cut through the thickness of the top layer around each portion 35 of the top layer 32 that contains the image (as shown in FIG. 2) so that each image portion 35 can be detached from the support release layer 30 and function as a sticker/reminder. The adhesive 34 should be selected to be pressure sensitive and the release layer 30 should be selected to enable the sticker to be detached from the release layer with the adhesive film remaining attached to the backside of the sticker. In accordance with example embodiments the support release layer should be readily visually distinguishable from the images so that when a sticker is removed its absence will be immediately apparent. In some cases it may be desirable to form the support layer 30 from colored stock of a readily distinguishable, contrasting color different from that of the images on the release layer. Alternately, the support layer 30 may be formed from a transparent or translucent material and may be imprinted with indicia (such as checkmarks or other encouraging or confirming symbols indicating that the dosage has been taken) on its externally facing back side with the indicia being in registry with each cell associated with a detachable sticker. In this embodiment when the sticker is detached the indicia aligned with the sticker will be visible through the transparent or translucent support release layer, thus providing an indication that the dose has been administered. In this embodiment the support layer may be formed from a polymeric or paper-like material.

FIG. 3 is an illustration of another embodiment of the invention as may be employed in circumstances where, in addition to providing an indication that medication has been taken, it also is desirable to record a physiological condition of the patient or other observation at that time, such as the patient's temperature or other physiological information. In this embodiment the lower portion of the panel grid may be arranged to include a sticker 35 for each column and arranged in one row to indicate whether the dosage has been administered and with rows 24A, 24B, 24C defining cells where information can be recorded such as day, time and temperature. The rows may be preprinted with indicia indicating day, time and temperature. This embodiment also illustrates that the upper portion of the panel may include a space 18 to record the patient's name or other identification. This embodiment illustrates an alternate arrangement of a die cut hook 17 to facilitate attachment to a bottle.

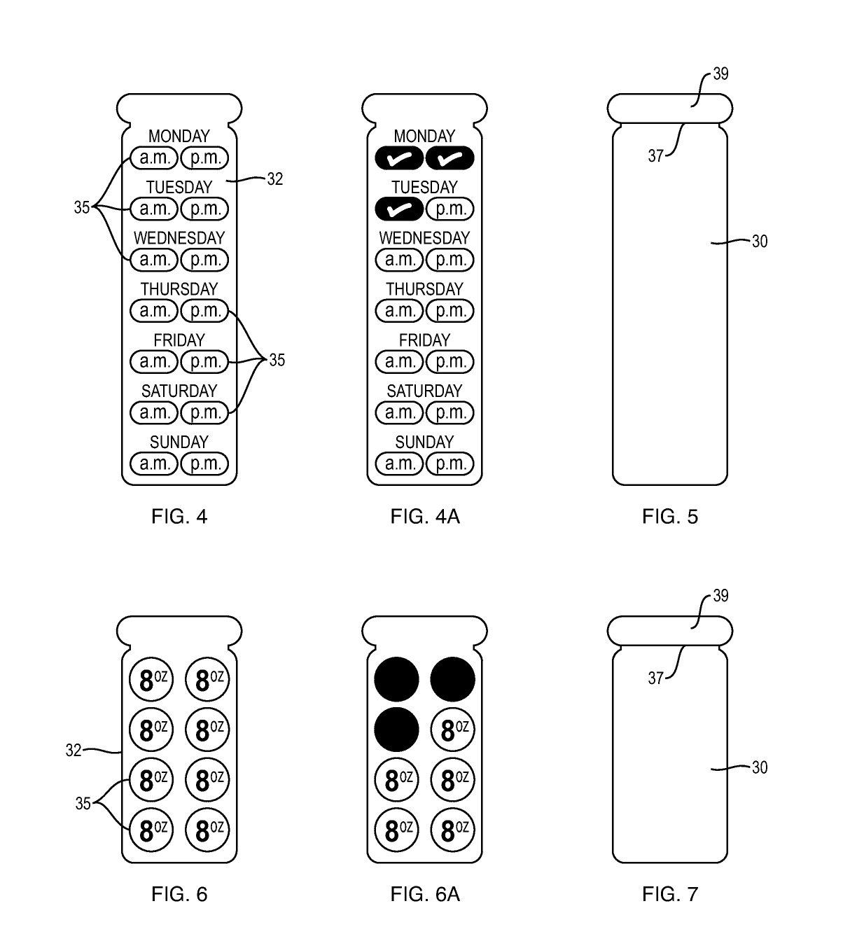

FIGS. 4 and 5 illustrate of another embodiment as may be used, for example, to track, record or serve as a reminder to take vitamins or supplements or the like. In this embodiment, detachable stickers 35 may be provided in columns reflecting the morning and an afternoon dosage for each day. As the vitamin dosage is taken, the stickers are removed to reveal a visually distinguishable image (e.g., contrasting color, etc.) providing confirmation that the vitamin has been taken. In this, as well as with other panel embodiments the release support layer 30 may be cut along a line 37 at the back of the panel to leave a removable strip 39 along the upper portion of the panel as shown in FIG. 5. The cut should not go through the adhesive film so that the panel may be adhered to the container simply by detaching the removable strip from the panel to expose the adhesive film thus enabling the panel to be adhered directly to the medication bottle, box or other container. In an alternate configuration, it may sometimes be desirable to provide a separate adhesive strip on the support layer. FIG. 4A shows the device of FIG. 4 in which several stickers have been removed and in which the support release layer has a checkmark or other indicia that the doses have been administered.

FIGS. 6 and 7 illustrate another embodiment of the invention as may be used, for example, simply to keep a record of the frequency or quantity of liquids or other consumable that have been ingested over the course of a day. This embodiment, as with the embodiment of FIGS. 4 and 5, may be attached to the container by providing a removable portion 39 of the support release layer by which the adhesive can be exposed from the backside of the panel and applied to the container. In this embodiment, depicting the number of 8-ounce glasses of water ingested during the day, there are provided stickers that are separable from the panel to reveal confirmation of the number of glasses ingested over the course of the time period, here one day. FIG. 6A shows the device of FIG. 6 in which several stickers have been removed and in which the support release layer has a visibly contrasting appearance to indicate that the doses have been administered.

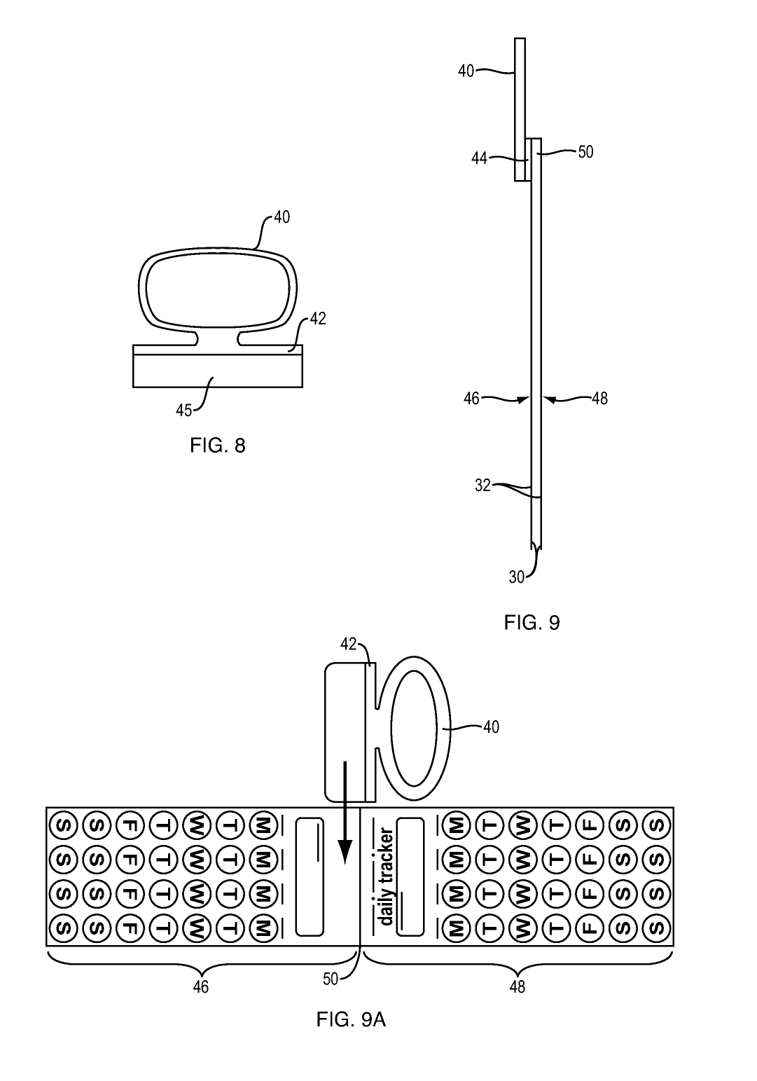

Panels in accordance with the invention may be attached by other means, including coupling with an elastic band device that can attach to the container and has an attached tab with an adhesive strip to which the panel can be attached. FIGS. 8 and 9 illustrate one such elastic band that includes an elastic loop 40 adapted to be placed over a neck of a bottle or stretched, if necessary, to fit about a container with a different shape or around a body of a container such as a medicine bottle or a tubular dispenser (e.g., ointment, toothpaste). The elastic loop 40 is attached to a tab 42 which may be formed in one piece with the loop 40. The tab 42 has a strip of adhesive 44 that is covered by a peel-away cover 45 to expose the adhesive. Elastic devices of this type are commercially available, for example, from Bedford Industries, Inc, Worthington, Minn. A panel in accordance with the invention can be attached by securing its upper portion 12 to the adhesive strip 44. The panel may be in the form of a folded panel, as suggested in FIGS. 9 and 9A, in which the panel is folded at its mid-length to define a pair of substantially similar panel segments 46, 48, each of which extends downwardly from the fold 50 and has its stickers facing outwardly toward the user when the panel is attached to the container. The tab 40 comes backed with a durable adhesive 45 which is then applied to the back top edge at the fold 50 to create a double facing panel that can be used from either side.

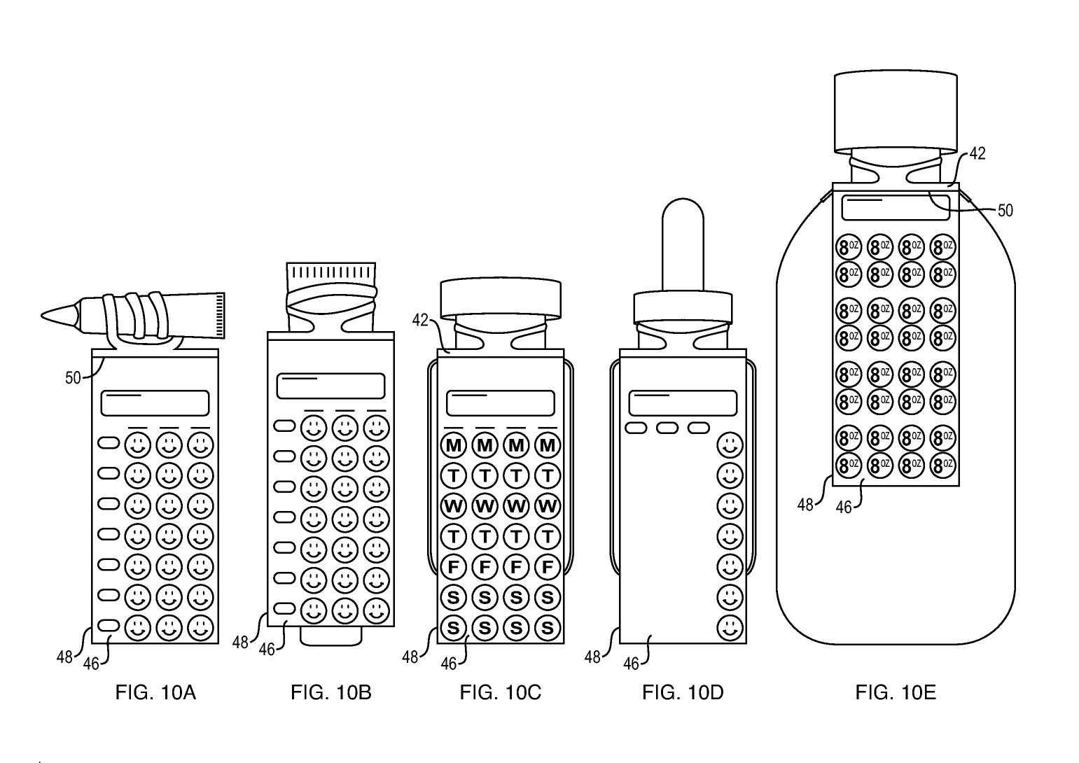

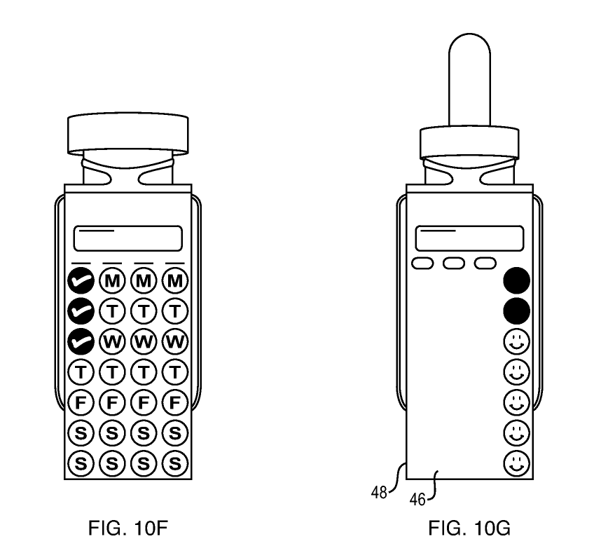

FIGS. 10A-10E illustrate various containers to which a number of folded panels are attached by the elastic loop arrangement of FIGS. 8 and 9. FIG. 10A illustrates attachment to a tube such as may contain medication in ointment form in which the elastic loop is wrapped several times about the tube and in which the panel is arranged to track three doses per day for seven days on each panel segment. FIG. 10B shows the device attached to another container configuration, also to track three doses per day for seven days on each panel segment. FIG. 10C shows an embodiment in which the panel omits a separate column to reflect the day of the week but, instead uses stickers with the images in each row indicating the day of the week to which the dose pertains. FIG. 10D shows the device attached to a container of a liquid substance such a medicine that is administered with a dropper. FIG. 10E is a bottle intended to hold a liquid (e.g., water) to facilitate tracking the number of times the liquid has been consumed. FIG. 10F is an illustration similar to FIG. 10C in which several stickers have been removed to reveal underlying indicia (e.g., checkmarks on a visually distinguishable background) of dosage administration. FIG. 10G is an illustration similar to FIG. 10D in which several stickers have been removed to reveal underlying visually distinguishable background indicating dosage administration.

In the foregoing illustrative description, the panels have been described as having rows for each day or other time interval and columns representing the dosages to be administered. It should be understood that other panel arrangements may be used, for example, with days, etc. represented in the columns and dosages in the rows. It also should be understood that the invention as well as the term “dose” or “dosage” as used herein is not intended to be limited to the administration of medications or any other particular type of treatment, but may include administration of quantities of a substance from a container of anything to be ingested or applied to a person.

In the examples, the plurality of indicators are arranged in a grid. The grid includes a plurality of columns and rows defining a plurality of cells. The columns represent one of dosage or time intervals and the rows representing the other of dosage or time intervals. Each of the plurality indicators is operable with a respective cell of the plurality of cells. As an example, each cell can include a removable sticker that, when removed, provides the visual indication of a dosage corresponding to a dosage at a time interval as represented by the position of the cell within the columns and rows. In this manner, removal of a sticker within a given cell is indicative of administration of the substance within the container in accordance with a position (e.g. representing a time interval) of the given cell within the grid. In one configuration, the panel includes a transparent support layer that may be printed to include a visual identifier (e.g. a check mark) that is visually revealed upon removal of the sticker to assist in identifying usage of the substance within the container in accordance with a position of the given cell within the grid. By imprinting a transparent support layer on its outwardly exposed back side, the printing and fabrication process for the device may be simplified.

Also as noted above, the grid can include perforations that define the plurality of columns and rows defining the plurality of cells. The perforations enable separation of at least a portion of at least one column or at least one row to enable resizing of a number of cells in the grid of the panel. The resized number of cells can reflect a prescribed administration of the substance within the container to which the panel attaches. For example, if the original panel is a four by seven grid of cells (thus useful for administration of a drug four times per day for seven days), but the drug container to which the apparatus attaches contains a drug that is only administered twice a day for five days, the user of the apparatus is able to bend the perforations to resize the original four by seven grid to a two by five grid. This can be accomplished by bending the panel along the perforation of the portion of cells to be removed, in which case the perforations allow tearing of the panel to provide for this resizing.

From the foregoing it will be appreciated that the invention provides a compliance and record keeping aid that is extremely easy to use, is always available together with the medication or other substance being dispensed and provides, at a glance, the current state of the patient or person's dosage regimen. Although in most cases the invention may be used without requiring note taking or other manual record-keeping, in those circumstances (e.g., recording fever) where manual entries must be made, the invention provides a convenient and readily available means for doing so. The invention is particularly useful with elderly patients, with patients or persons requiring multiple caregivers who may be present at different times and with children where the inducement of receiving a sticker reward each time medicine is administered may facilitate administering medication to a child who otherwise may present resistance to a medication. The stickers may be given to the child for her amusement or may be accumulated toward another type of reward when a target number has been collected.

It should be understood, however, that the foregoing description of the invention is intended merely to be illustrative and that other modifications, embodiments and equivalents may be apparent to those skilled in the art without departing from the principles of the invention.

Having thus described the invention, what is claimed is:

1. An aid for facilitating compliance with and record keeping of a regimen of periodic doses of a substance from a container comprising:
a panel having upper and lower portions, the upper portion being attachable to the container;
the panel having a support release layer and a top layer adhesively attached to the support release layer by an intermediate adhesive layer, the top layer being detachable from the support layer together with the adhesive;
the lower portion of the panel defining a grid including a plurality of columns and rows defining a plurality of cells, the columns representing one of dosage or time intervals and the rows representing the other of dosage or time intervals;
a plurality of the cells in the top layer, each having an image, each image-bearing portion of the top layer being separated from the adjacent portions of the top layer whereby each image-bearing portion can be detached and removed from the panel, thereby to expose a portion of the underlying support layer;
the support layer having a different visual appearance from that of the image-bearing portion of the top layer whereby a record of the administration of a dose of the substance may be determined by the absence of the image from the panel.

2. The aid as defined in claim 1 wherein the support layer has a contrasting color to that of the image-bearing portion of the top layer.

3. The aid as defined in claim 1 wherein the regions of the support layer that underlie the image-bearing portions of the top layer each include an indicia confirming that the dose has been administered.

4. The aid as defined in claim 1 wherein the panel is attachable by the upper portion of the panel having an aperture adapted to fit over the neck of a bottle.

5. The aid as defined in claim 1 wherein the panel is attachable to the container by the upper portion of the panel having an adhesive member at the back face of the panel whereby the panel can be adhesively attached to the container.

6. The aid as defined in claim 1 wherein the upper portion of the panel is attachable to the container by the support release layer having a removable portion thereof defining a tear strip at the upper portion of the panel, whereby the tear strip can be detached from the panel to expose the adhesive film at the back of the panel, thereby enabling the panel to be adhered to the container.

7. The aid as defined in claim 1 wherein the panel is attachable to the container by an elastic band having a tab attached thereto, the upper portion of the panel being attached to the tab.

8. The aid as defined in claim 1 further comprising:
the panel having a plurality of columns or rows reflecting a plurality of dosages per time interval, the panel being formed with one or more weakened tear lines that extend between the dosages, whereby one or more of the columns or rows reflecting dosages may be detached from the panel so that the remaining columns or rows reflecting dosages may be made to correspond to a prescribed number of doses per time interval.

9. The aid as defined in claim 1 further comprising:
the panel being folded in the region of its midportion to define a front segment and a back segment with the top layer facing outwardly and the support layer facing inwardly whereby after the image-bearing portions of the top layer on one segment have been removed the panel can be detached from the container and reattached to present the unused portion of the panel to the user.

10. The aid as defined in claim 1 wherein at least one cell associated with each dose defines a blank region to receive physiological information corresponding to the time at which the dose is administered.

11. An apparatus for tracking periodic doses of a substance from a container, the apparatus comprising:
a coupling device operable to secure the apparatus to the container;
a panel coupled to the coupling device, the panel including a plurality of indicators, each indicator operable to be physically manipulated to provide a visual indication of administration of at least one dose of the substance from the container.

12. The apparatus of claim 11 wherein the plurality of indicators are arranged in a grid, the grid including a plurality of columns and rows defining a plurality of cells, the columns representing one of dosage or time intervals and the rows representing the other of dosage or time intervals, each of the plurality indicators operable with a respective cell of the plurality of cells, operation of a indicator providing the visual indication of a dosage corresponding to a dosage at a time interval as represented by the position of the cell within the columns and rows.

13. The apparatus of claim 11 wherein the plurality of indicators are removable stickers.

14. The apparatus of claim 13 wherein removing of a sticker within a given cell is indicative of administration of the substance within the container in accordance with a position of the given cell within the grid.

15. The apparatus of claim 13 wherein the panel includes a sticker backing that resides under each of the indicators, the sticker backing including a visual identifier that is visually exposed upon removal of the sticker to assist in identifying usage of the substance within the container in accordance with a position of the given cell within the grid.

16. The apparatus of claim 11 wherein the grid includes perforations that define the plurality of columns and rows defining the plurality of cells, and wherein the perforations enable separation of at least a portion of at least one column or at least one row to enabling resizing of a number of cells in the grid of the panel, the resized number of cells reflecting a prescribed administration of the substance within the container to which the panel attaches.

17. The aid as defined in claim 1 wherein the support layer is formed from a transparent or translucent material, the outwardly exposed surface of the support layer being imprinted with an image or pattern that will be visible through the support layer when the sticker is removed.

18. The apparatus as defined in claim 15 wherein the sticker backing is transparent or translucent, the outwardly exposed surface of the backing being imprinted with an image or pattern that will be visible through the backing when the sticker is removed

19. A method of tracking periodic dosages of a substance from a container of the substance comprising:
attaching a panel to the container, the panel having a supporting release layer and an array of detachable stickers arranged on the supporting release layer in a grid that includes a plurality of columns and rows defining a plurality of cells, each containing a sticker, the columns representing one of dosage or time intervals and the rows representing the other of dosage or time intervals;
upon administering a dose, detaching the sticker corresponding to that dose from the panel, the region of the support layer in the cell of the detached sticker being visually distinguishable from the cell containing the remaining stickers, thereby to provide a indication of those doses that have and have been administered from those that have not.

20. The method as defined in claim 19 wherein the dose is administered to a child and further comprising:
after administering the dose giving the sticker to the child as a reward for taking the substance.
